(19) United States
(12) Patent Application Publication
(10) Pub. No.: US 2003/0069856 A1
(43) Pub. Date: Apr. 10, 2003

(54) Method and system for performing money transfer transactions

(75) Inventors: Dean A. Seifert, Parker, CO (US); Earney E. Stoutenburg, Parker, CO (US); David A. Owen, Castle Rock, CO (US); Maura A. Fitzgerald, Aurora, CO (US)

Correspondence Address: BROOKS & KUSHMAN, 1000 TOWN CENTER 22ND FL, SOUTHFIELD, MI, 48075

(73) Assignee: First Data Corporation, Hackensack, NJ

(21) Appl. No.: 09/975,171

(22) Filed: Oct. 10, 2001

(51) Int. Cl. G06F 17/60; H04L 9/00; H04K 1/00

(52) U.S. Cl. 705/73

(57) ABSTRACT

A method for performing a money transfer receive transaction includes loading payout funds, corresponding to a desired amount of money to be transferred from a sender to a recipient, in a payout account associated with a payout card, such that the payout funds are electronically accessible by the recipient using the payout card. A system for performing a money transfer receive transaction is also provided.

### BACKGROUND OF THE INVENTION

1. Field of the Invention

The invention relates to a method and system for performing money transfer transactions.

2. Background Art

A money transfer transaction performed with a financial services institution may include a money transfer send transaction, or send transaction, and a money transfer receive transaction, or receive transaction. Under a send transaction, a sender sends or “wires” money to a recipient through the financial services institution. Under a receive transaction, the recipient receives money through the financial services institution. Many such transactions are also facilitated by businesses, organizations or other entities that act as agents of the financial services institution.

Various methods are known for performing send transactions. One known method, for example, involves a sender completing a transaction form and providing the form to an agent. The transaction form includes such information as the desired amount of money to be sent, sender information, and recipient information. The agent then enters the information from the transaction form into a computer, such as a point of sale terminal, that is in communication with a central data base or host computer of the financial services institution. Alternatively, the agent may communicate the information to a representative of the financial services institution, and the representative may provide additional information to the agent that is added to the transaction form. Next, the agent collects from the sender the desired amount of money to be sent plus any applicable fees and/or taxes.

Another method of performing a send transaction involves providing a telephone at an agent location with which a sender can access an operator of a financial services institution. The sender then provides information to the operator, such as recipient name, sender name, desired amount of money to be sent, and agent location. Next, the operator transmits a transaction form, which includes the information provided by the sender, to an agent at the agent location via a facsimile transmittal machine. The sender then signs the transaction form. Next, the agent collects from the sender the desired amount of money to be sent plus any applicable fees and/or taxes. The agent then signs the transaction form and transmits the form back to the operator. Next, the operator enters the information from the transaction form into a central data base of the financial services institution.

Still another method of performing a send transaction includes providing a sender an access card that is used to access a central data base of a financial services institution. The sender provides the access card to an agent, and the agent enters the access card into a terminal so as to retrieve from the data base a list of potential recipient names previously identified by the sender. After the list has been retrieved, the sender selects a desired recipient from the list, and provides a desired amount of money to be sent to the selected recipient. Next, the agent collects from the sender the desired amount of money to be sent plus any applicable fees and/or taxes.

A prior method of performing a receive transaction involves a sender providing a recipient a money transfer control number (MTCN), which represents a unique key to transaction information or data stored in the data base. The recipient may then enter the MTCN on a form, which is provided to an agent. Next, the agent accesses the data base using a terminal, and obtains a receive amount that corresponds to the MTCN. Alternatively, the agent may obtain the receive amount, or other information related to the receive transaction, by entering the recipient's name, sender's name, or sender's telephone number into the terminal.

The agent may then print a check for the receive amount. Next, the check is provided to the recipient. The recipient then endorses the check and receives cash from the agent. The agent may then use the signed check to obtain reimbursement from the financial services institution.

If the receive amount exceeds the agent's payout limit, which is the amount the agent is authorized or willing to pay out in cash to the recipient, then the agent may issue multiple checks, such as one check for an amount up to the payout limit, and one or more additional checks for the remainder of the receive amount. The additional check or checks must then be taken elsewhere for encashment.

Because this method of performing a receive transaction requires the agent to have significant cash on hand, this method is not practical for agents that typically do not have significant cash available. As a result, the number of agent locations available to a recipient is limited.

### SUMMARY OF THE INVENTION

The invention addresses the shortcomings of the prior art by providing a method for performing a money transfer receive transaction that involves loading payout funds in a payout account that is electronically accessible by a recipient. As a result, an agent that may be involved in the transaction does not need to dispense significant amounts of cash to the recipient. A system for performing such a transaction is also provided.

Under the invention, a method for performing a money transfer receive transaction includes loading payout funds, corresponding to a desired amount of money to be transferred from a sender to a recipient, in a payout account associated with a payout card, such that the payout funds are electronically accessible by the recipient using the payout card.

The method may further include receiving at a host computer system, prior to the loading step, card identifying information associated with the payout card, and storing the card identifying information and payout funds on the host computer system. In addition, the method may include receiving input associated with the payout card, comparing the input to the card identifying information stored on the host computer system, and allowing funds corresponding to the payout funds to be dispensed to the recipient if the input matches the card identifying information stored on the host computer system.

Because a transaction fee may be imposed in order to dispense the payout funds to the recipient, the method may include allowing the payout account to be exceeded by a predetermined amount in order to cover the transaction fee. Alternatively, the method may include loading an additional amount in the payout account to cover such a transaction fee. As yet another alternative, the method may include receiving from the recipient an amount of money sufficient to cover the transaction fee. Moreover, the method may include automatically calculating the transaction fee.

Further under the invention, a system for performing a money transfer receive transaction is provided. The system includes a host computer system having instructions for loading payout funds, corresponding to a desired amount of money to be transferred from a sender to a recipient, in a payout account associated with a payout card, such that the payout funds are electronically accessible by the recipient using the payout card.

These and other objects, features, and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic diagram of a system according to the invention for performing money transfer transactions;

FIGS. 2 (2a, 2b and 2c) is a flow chart illustrating operation of a method according to the invention for performing money transfer transactions; and

FIG. 3 is a flow chart illustrating further operation of the method according to the invention.

### DETAILED DESCRIPTION OF THE PREFERRED EMBODIMENT(S)

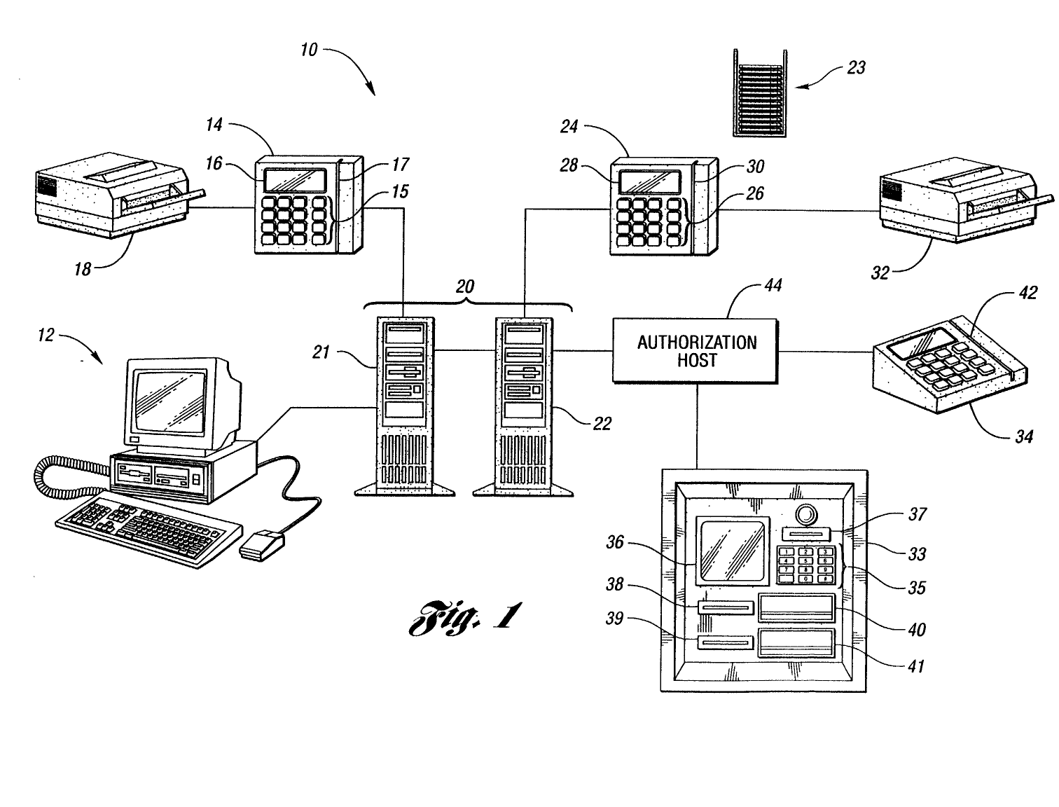

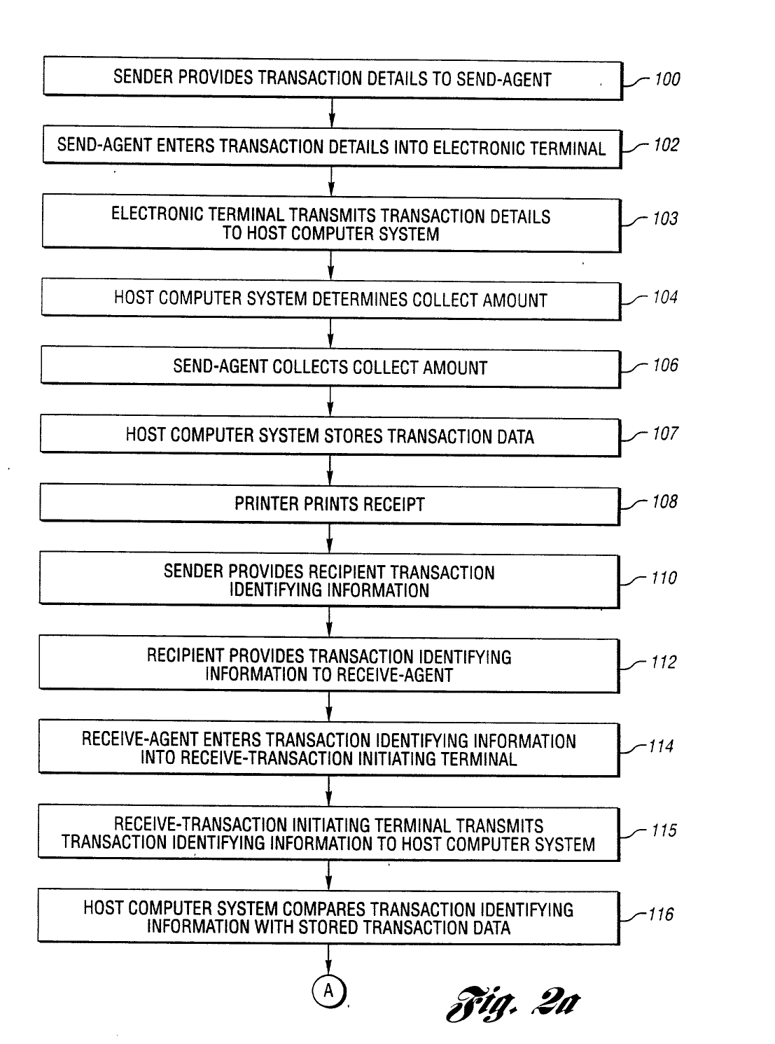

FIG. 1 shows a system 10 according to the invention for performing electronic data transfers to effect money transfer transactions with a financial services institution. Generally, a money transfer transaction according to the invention may be divided into two distinct transactions, a send transaction and a receive transaction. Under the send transaction, a sender electronically sends or “wires” money to a recipient through the financial services institution. Under the receive transaction, the recipient receives the money through the financial services institution. Money transfer transactions may also be facilitated by an agent that may receive a commission for each transaction. Agent, as used herein, refers to a person that assists in one or more money transfer transactions through the financial services institution, but is not a direct employee of the financial services institution. Furthermore, both the sender and the recipient may be referred to as customers of the financial services institution and/or the agent.

The system 10 includes one or more send-transaction initiating devices, such as a personal computer 12 and/or an electronic terminal 14, for initiating the send transaction. The send-transaction initiating devices 12, 14 may be located in any suitable area, such as an agent location, a sender's home or office, or a public place. The electronic terminal 14 may include a keypad 15, a display device 16 and a card reader 17. A printer 18 may also be provided in communication with the electronic terminal 14 for printing such things as receipts or other printed records. While the electronic terminal 14 may be any suitable electronic device such as an unattended automated teller machine (ATM), in the embodiment shown in FIG. 1, the electronic terminal 14 is an FDX-400® available from Western Union of Greenwood Village, Colo.

The send-transaction initiating devices 12, 14 are preferably in communication, either directly or indirectly, with a host computer system 20 of the financial services institution. For example, send-transaction initiating devices 12, 14 may be linked to the host computer system 20 via any suitable communication network such as a local area network, a wide area network, a dial-up network, the Internet, a wireless network or any combination thereof. While the host computer system 20 may include one or more host computers, in the embodiment shown in FIG. 1, the host computer system 20 includes a money transfer host 21 and card account host 22 in communication with the money transfer host 21. Furthermore, the send-transaction initiating devices 12, 14 may be used to provide transaction details to the host computer system 20, as explained below in detail.

The system 10 also includes a source 23 of payout cards and a receive-transaction initiating terminal 24 in communication with the host computer system 20, either directly or indirectly. The source 23 of payout cards may include a plurality of payout cards, such as anonymous payout cards, that are issued to recipients during receive transactions, as explained below in detail. Each payout card may have an account code printed or recorded thereon, and each account code corresponds to a particular payout account maintained on the host computer system 20. Alternatively, account codes may be assigned by the host computer system 20 and written onto the payout cards by the receive-transaction initiating terminal 24. In either case, each account code may be an account number, for example. As another example, each account code may include one or more alpha-numeric characters, symbols and/or images. In addition, each payout card may be provided with an identification code printed thereon or attached thereto. Each identification code may be an identification number, or include one or more alpha-numeric characters, symbols and/or images. Furthermore, for security purposes or other purposes, each identification code may be covered by any suitable means, such as a peel-off sticker or scratch-off material.

Alternatively, identification codes may be provided in any suitable manner. For example, each payout card may be provided with a separate piece of paper or card that includes the corresponding identification code. More specifically, each payout card may be provided in an envelope, or other container, that also includes another smaller envelope having a piece of paper with the corresponding identification code printed thereon. As another example, when a particular payout card is issued to a recipient, the payout card may be provided along with a receipt, such as a two-ply receipt, that has an identification code printed thereon. In such a case, the host computer system 20 may be used to communicate the identification code to the receive-transaction initiating terminal 24, which then prints the identification code on the receipt. As yet another example, after a particular payout card is issued to a recipient, the recipient may be required to call a particular telephone number to obtain an identification code. In such a case, the identification code may not be available until the payout card has been activated by the agent that issued the payout card.

The receive-transaction initiating terminal 24 may be linked to the host computer system 20 via any suitable communication network, such as a local area network, wide area network, a dial-up network, the Internet, a wireless network or any combination thereof. Furthermore, the receive-transaction initiating terminal is used to initiate the receive transaction, as explained below in greater detail, and includes a keypad 26, a display device 28, a card reader 30 and a card writer 31. A printer 32 may also be provided in communication with the receive-transaction initiating terminal 24 for printing such things as negotiable instruments, receipts and/or other printed records. While the receive-transaction initiating terminal 24 may be any suitable electronic device, in the embodiment shown in FIG. 1, the receive-transaction initiating terminal 24 is also an FDX-400®.

In addition, the system 10 includes a receive-transaction fulfillment terminal, such as an ATM 33 that is used to dispense cash to the recipient, or a point-of-sale (POS) terminal 34 that may be used for in-lane purchases, as explained below in detail. The ATM 33 may include a keypad 35, a display device 36, a card reader 37, a printer 38, a cash accepting device 39 and a cash dispensing device 40. The POS terminal 34 includes a card reader 42, and may also include one or more of the other features of the ATM 33. The receive-transaction fulfillment terminal 33, 34 may be linked to the host computer system 20 via any suitable communication network such as a local area network, a wide area network, a dial-up network, the Internet, a wireless network or any combination thereof. Furthermore, such a communication network may be public (e.g, CIRRUS®, PLUS®, MAC®, etc.) or private so as to provide a barrier to entry.

The ATM 33 and POS terminal 34 are in communication with an authorization source or host 44 via a debit authorization network, such as MAC® or PLUS®, or via any other suitable communication network, such as a local area network, wide area network, a dial-up network, the Internet, a wireless network or any combination thereof. The authorization host 44 is in communication with the host computer system 20 via any suitable communication network. Alternatively, the authorization host 44 may be part of the host computer system 20.

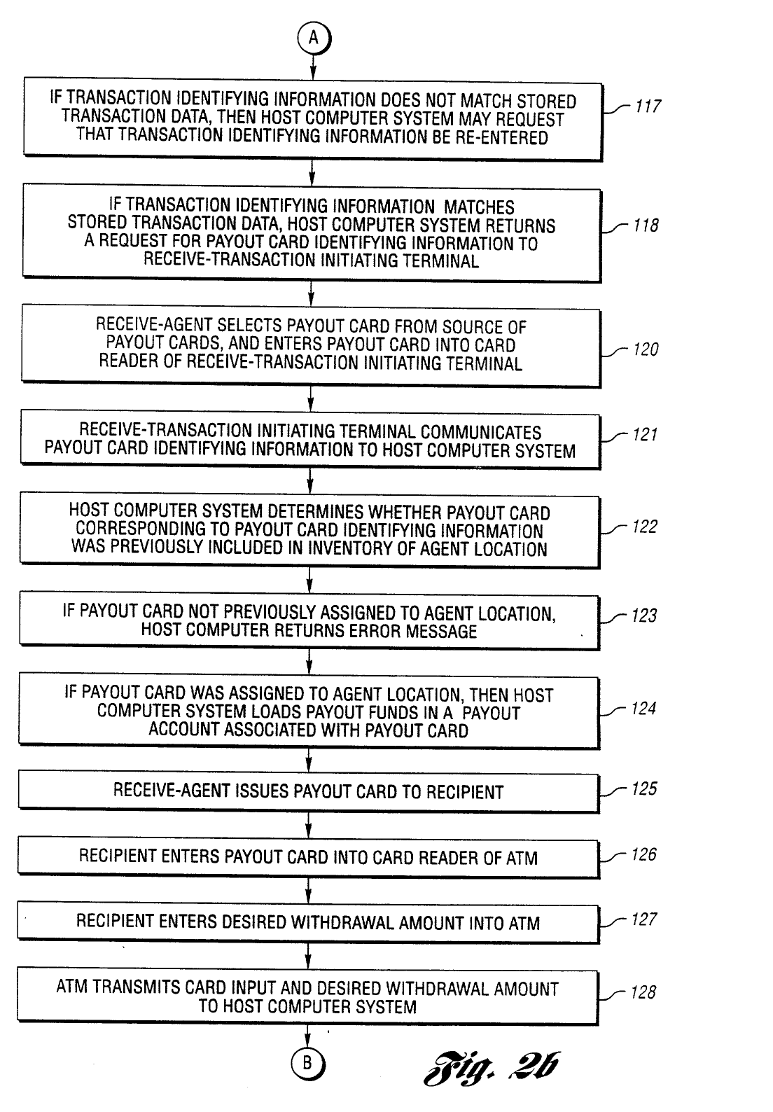

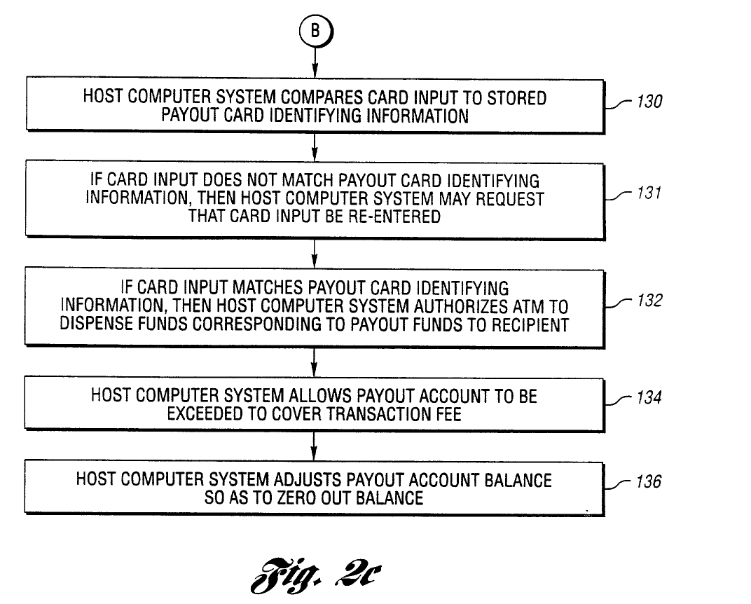

FIG. 2 is a flow chart illustrating operation of a method or system, such as the system 10, for performing money transfer transactions according to the invention. As will be appreciated by one of ordinary skill in the art, many of the steps in the flow chart, such as steps performed by the host computer system 20 or other electronic device, represent control logic or instructions that may be effected or implemented by hardware, software, or a combination of hardware and software.

As mentioned above, each money transfer transaction may be divided into a send transaction and a receive transaction. At step 100, the sender begins the send transaction by providing transaction details to a send-agent, who is an agent that assists in send transactions and may also assist in receive transactions. The transaction details may include, for example, the sender's name and address, recipient name, and/or a desired amount of money to be transferred to the recipient, which may be referred to as principal amount. At step 102, the send-agent enters the transaction details into the electronic terminal 14 using, for example, the keypad 15. At step 103, the electronic terminal 14 transmits the transaction details to the host computer system 20. If the principal amount to be sent is over a certain amount, then the terminal 14 or the host computer system 20 may also request supplemental information from the sender, such as driver's license number, social security number, date of birth, etc. in order to comply with institutional and/or regulatory requirements.

Next, at step 104, the host computer system 20 determines a collect amount, which represents the principal amount plus any service fee and taxes, if applicable, and returns the collect amount to the electronic terminal 14 for display on display device 16. The host computer system 20 may also return a code, such as a money transfer control number (MTCN), to the electronic terminal 14. The send-agent then collects the collect amount from the sender, as indicated at step 106. At step 107, transaction data, which may include some or all of the transaction details and/or the MTCN, is stored on the host computer system 20. At step 108, the printer 18 may then be used to automatically print a receipt, which may include the MTCN, thereby ending the send transaction.

Alternatively, the send transaction may be carried out in any suitable manner. For example, instead of using the electronic terminal 14, the send-agent may use a telephone (not shown) to contact an operator or other employee of the financial services institution, and to provide transaction details to the operator. The operator may then communicate with the host computer system 20 to carry out the send transaction. As another example, the sender may utilize the personal computer 12 to access the host computer system 20 over the Internet, and to provide transaction details to the host computer system 20. The sender may then pay the collect amount using a credit card. As another example, the send transaction may be carried out in multiple stages, such as disclosed in co-pending application Ser. No. 09/427,249, which is assigned to the assignee of the present invention and is hereby incorporated by reference in its entirety. Under this approach, send transactions may be “staged” using a computer, telephone, or by other means, and then “fulfilled” at an agent location. As yet another example, the send transaction may be carried out utilizing an ATM, such as disclosed in U.S. Pat. No. 5,650,604, which is hereby incorporated in its entirety. Under any of the above approaches, transaction data, which may include some or all of the transaction details described above and/or an MTCN, may be stored on the host computer system 20.

At step 110, the receive transaction begins with the sender providing the recipient transaction identifying information, which may include some or all of the transaction details and/or the MTCN. During the receive transaction, the principal amount may be referred to as the receive amount. Next, at step 112, the recipient provides the transaction identifying information to a receive-agent, who is an agent that assists in receive transactions. It is to be understood that the receive-agent may also assist in send transactions. The recipient may also indicate to the receive agent whether or not he or she desires to receive a payout card for at least a portion of the receive amount.

At step 114, the receive-agent enters the transaction identifying information into the receive-transaction initiating terminal 24 using, for example, the keypad 26. The receive-transaction initiating terminal 24 then transmits the transaction identifying information to the host computer system 20, as indicated at step 115. Depending on the dollar value of the receive amount, or other characteristics of the receive transaction, the host computer system 20 may prompt the receive agent via the receive-transaction initiating terminal 24 to obtain identification, such as a driver's license, from the recipient. Next, the host computer system 20 compares the transaction identifying information with the stored transaction data, at step 116. If the transaction identifying information does not match the stored transaction data, then the host computer system 20 may request that the transaction identifying information be re-entered, as indicated at step 117. If, after one or more subsequent attempts, the transaction identifying information still does not match the stored transaction data, then the transaction may be terminated.

If, on the other hand, the transaction identifying information matches the stored transaction data, and the receive-agent has indicated that a payout card is to be issued for the receive amount, then the host computer system 20 returns a request for payout card identifying information to the receive-transaction initiating terminal 24, at step 118. Next, at step 120, the receive-agent selects a payout card from the source 23 of payout cards, and enters the payout card into the card reader 30, such as by swiping the payout card through the card reader 30, so as to enter the payout card identifying information into the receive-transaction initiating terminal 24. Alternatively, the payout card identifying information may be entered manually using keypad 26, or by any other means such as a barcode scanner, MICR scanner, OCR scanner, voice scanner, infrared scanner, or any other means or combination thereof. The payout card identifying information may include an identification code and/or an account code associated with the payout card.

Next, at step 121, the receive-transaction initiating terminal 24 communicates the payout card identifying information to the host computer system 20. At step 122, the host computer system 20 then determines whether the payout card corresponding to the payout card identifying information was previously included in inventory of the receive-agent, and whether the payout card is still active and eligible for loading of payout funds. For example, account codes for all payout cards provided to the receive-agent or associated agent location, are preferably stored on host computer system 20 and/or another computer in communication with host computer system 20. Upon receiving the payout card identifying information for the payout card involved in the receive transaction, the host computer system 20 may then compare the corresponding account code with the stored account codes to confirm that the payout card was previously assigned to the agent location.

If the payout card was not previously assigned to the agent location, then the host computer system 20 may return an error message to the receive-transaction initiating terminal 24, and the receive transaction may be terminated, as indicated at step 123. Alternatively, the host computer system 20 may request payout card identifying information for another payout card.

If the payout card was previously assigned to the agent location, the host computer system 20 then stores the payout card identifying information and loads, or otherwise stores, payout funds corresponding to a portion or all of the receive amount in a payout account associated with the account code of the payout card, as indicated at step 124. For example, the money transfer host 21 may communicate with the card account host 22 so as to load payout funds in the payout account. The payout account is preferably maintained on the card account host 22 such that the payout account is electronically accessible, as explained below in detail. Next, at step 125, the receive-agent prints a receipt, and issues the receipt and the payout card to the recipient if, for example, authorized by the host computer system 20 to do so.

Alternatively, if the receive-transaction initiating terminal 24 includes card writer 31, steps 118 through 124 may be omitted. Instead, if the transaction identifying information matches the stored transaction data, and the receive-agent has indicated that a payout card is to be issued for at least a portion of the receive amount, then the host computer system 20 may return a request to the receive-transaction initiating terminal 24 that a payout card be entered into the card writer 31. Next, the receive-agent may select a blank payout card (i.e., a payout card with no account code printed or recorded thereon from the source 23 of payout cards, and enter the payout card into the card writer 31. The host computer system 20 may then assign or otherwise provide an account code and an identification code that correspond to a payout account on the host computer system and that are to be used with the payout card. The host computer system 20 also loads payout funds corresponding to a portion or all of the receive amount in the payout account. Next, the host computer system 20 may store the account code and/or identification code as payout card identifying information, and transmit or otherwise communicate the account code and identification code to the receive-transaction initiating terminal 24. The receive-transaction initiating terminal 24 may then write the account code to the payout card, such as on a magnetic strip of the payout card, using the card writer 31. The receive-transaction initiating terminal 24 may also print the identification code on a receipt using the printer 32. Next, the receive-agent may issue the payout card and receipt to the recipient if, for example, authorized by the host computer system 20 to do so.

Alternatively, the receive transaction may be initiated in any suitable manner. For example, the recipient may contact an employee of the financial services firm, such as a customer services representative (CSR), using a telephone so as to provide the transaction identifying information to the CSR. Depending on the dollar value of the receive amount, or other characteristics of the receive transaction, the CSR may request that the recipient provide his or her driver's license number. The CSR may then access the host computer system 20 so as to compare the transaction identifying information with the stored transaction data. If the transaction identifying information matches the stored transaction data, the CSR may then provide the recipient a receive-transaction control code (RCC), which is also stored on the host computer system 20. The recipient may then provide the RCC and some or all of the transaction identifying information to the receive-agent, and the receive-agent may transmit the RCC and some or all of the transaction identifying information to the host computer system 20 using the receive-transaction initiating terminal 24. If the RCC and the transaction identifying information matches the stored RCC and stored transaction data, a payout card may then be issued to the recipient in a manner similar to the process described above in detail. Additional details regarding use of RCC's is disclosed in co-pending application Ser. No. 09/427,249.

As another example, the recipient may use a personal computer or other electronic device, such as a personal digital assistant or cellular telephone, to communicate with the host computer system 20 and provide the transaction identifying information to the host computer system 20. If the transaction identifying information matches the stored transaction data, then the host computer system 20 may provide an RCC to the recipient. The recipient may then use the RCC in a similar manner as described above to obtain a payout card.

As yet another example, the receive transaction may be initiated by using the ATM 33, which may include a card dispensing device 41 that includes a plurality of payout cards, such as described above with respect to the source 23 of payout cards. Under this approach, the recipient may enter the transaction identifying information into the ATM 33 using the keypad 35. The ATM 33 then transmits the transaction identifying information to the host computer system 20 through the authorization host 44. Next, the host computer system 20 compares the transaction identifying information with the stored transaction data. If the transaction identifying information matches the stored transaction data, then the host computer system 20 may load payout funds corresponding to a portion or all of the receive amount in a payout account associated with a payout card contained in the card dispensing device 41. The host computer system 20 may then authorize or otherwise allow the ATM 33 to dispense the payout card to the recipient through the card dispensing device 41. Alternatively, the host computer system 20 may load payout funds into a payout account associated with a payout card that is presented by the recipient. For instance, the recipient may enter a previously issued payout card into the card reader 37 so as to enter payout card identifying information into the ATM 33.

Once the recipient obtains the payout card, the recipient may use the payout card at one of the receive-transaction fulfillment terminals 33 or 34 to access the payout account. For example, at step 126, the recipient may enter the payout card into the card reader 37 of the ATM 33, such as by swiping the payout card through the card reader 37, so as to provide card input into the ATM 33. The card input may, for example, include some or all of the payout card identifying information. Alternatively, card input may be entered into the ATM 33 using the keypad 35. For example, if the identification code is covered at the time the payout card is issued to the recipient, the recipient may then uncover the identification code and enter the identification code into the ATM 33. As another example, if the identification code is provided on a separate receipt, the recipient may enter the identification code into the ATM 33 using the keypad 35. The recipient may also enter a desired withdrawal amount into the ATM 33 using the keypad 35, as indicated at step 127.

At step 128, the ATM 33 transmits the card input and the desired withdrawal amount to authorization host 44, which transmits the card input and the desired withdrawal amount to the host computer system 20. After receiving the card input, the host computer system 20 compares the card input to the stored payout card identifying information, as indicated at step 130. If the card input does not match the payout card identifying information, then the host computer system 20 may request that the card input be re-entered, as indicated at step 131. If, after one or more subsequent attempts, the card input still does not match the payout card identifying information, then the transaction may be terminated.

If, on the other hand, the card input matches the payout card identifying information, then the host computer system 20 authorizes or otherwise allows the ATM 33 to dispense funds corresponding to the payout funds to the recipient, at step 132. At step 134, the host computer system 20 may also allow the payout account to exceed the payout funds or go negative by a predetermined, configurable amount, such as $5.00, so as to cover any transaction fee charged by the owner or operator of the ATM 33. After some period of time, such as at the end of each day, the host computer system 20 may then zero out the payout account, as well as any other payout accounts associated with other money transfer transactions, as indicated at step 136. Alternatively, the ATM 33 may debit or otherwise deduct such a transaction fee from the payout account, if authorized to do so by the recipient and/or the host computer system 20. As another alternative, the ATM 33 may request that the recipient enter an amount of money sufficient to cover a transaction fee into the cash accepting device 39.

As yet another alternative, the host computer system 20 may load an additional amount in the payout account, at the time the payout funds are loaded into the payout account or at any other time, so as to cover any transaction fee. For example, the host computer system 20 may automatically calculate a transaction fee at the time of a debit request, and then load the transaction fee into the payout account. Such a transaction fee may be determined, for example, by assuming an even, whole dollar desired withdrawal amount, and attributing any additional requested debit amount to the transaction fee. More specifically, if the ATM 33 transmits a debit request of $301.95, the host computer system 20 may assume that the desired withdrawal amount for the recipient is $300, and that the remaining $1.95 is the transaction fee.

Advantageously, if the recipient does not withdraw funds corresponding to the full amount of the payout funds, the host computer system 20 may be configured to allow the recipient to initiate a second or other subsequent withdrawal, using the same payout card, at the ATM 33 or a different ATM. In such a case, the host computer system 20 may include instructions for allowing the payout account to further exceed the amount of the payout funds, or go further negative, to cover any additional transaction fees for the additional dispensing transaction, or the recipient may be responsible for any additional transaction fees.

Because the receive-agent does not need to dispense cash directly to the recipient, the system and method of the invention enable receive transactions to be carried out at or through agent locations that may not typically have large amounts of cash on hand. For example, convenience stores and gas stations may be able to perform receive transactions using the system and method of the invention.

Because the ATM 33 may be configured to only dispense funds in certain dollar increments, such as $20 increments, a situation may arise where funds corresponding to the entire receive amount cannot be dispensed by the ATM 33. In such a case, the receive-agent may issue directly to the recipient funds corresponding to a portion of the receive amount. For example, if the total receive amount is $412.62, the receive-agent may print a negotiable instrument, such as a money order or a check, for $12.62 using the first printer 32, and may also issue a payout card for $400.00. The recipient may then endorse the negotiable instrument and receive $12.62 directly from the receive-agent. Furthermore, the recipient may then use the payout card to obtain $400.00 from the ATM 33.

Alternatively, the receive-agent may decide for whatever reason, including a request by the recipient, to issue funds corresponding to some or all of the receive amount directly to the recipient using one or more negotiable instruments and/or cash. For example, if the receive amount totals $842.19, the receive-agent may print multiple checks or money orders totaling $342.19, and may also issue a payout card for $500.00. The host computer system 20 may be configured to provide authorization for each item to be issued to the recipient, or the host computer system 20 may provide a general authorization to the receive-agent to disburse the receive amount and allow the receive-agent to determine how to do so.

Because the system 10 and method of the invention enable money orders to be issued as part of receive transactions, if necessary, agent locations can handle money transfer transactions as well as money order sales using a single terminal, such as receive-transaction initiating terminal 24. As a result, each agent location may only need to stock money order forms, instead of both check forms and money order forms.

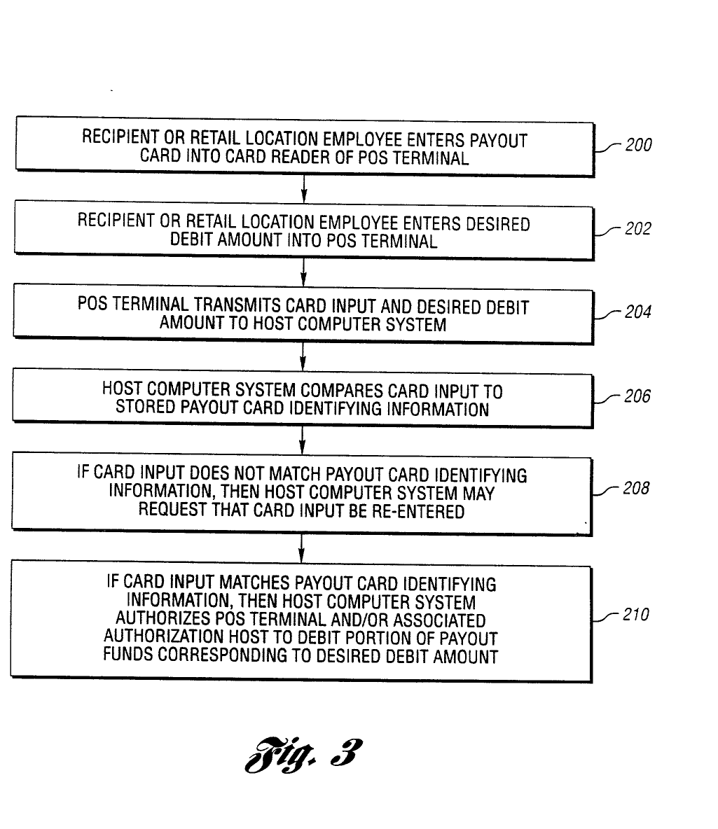

As an alternative to or supplement to using the ATM 33 to dispense funds, the recipient may use the payout card at POS terminal 34 to pay for purchases at a retail location, such as grocery store or convenience store. Under this approach, referring to FIG. 3, the recipient or an employee at the retail location may enter the payout card into the card reader 42 of the POS terminal 34, such as by swiping the payout card through the card reader 42, so as to provide card input into the POS terminal 34, as indicated at step 200. Again, the card input may, for example, include some or all of the payout card identifying information. Alternatively, card input may be entered into the POS terminal 34 using a keypad of the POS terminal 34. For example, if the identification code is covered at the time the payout card is issued to the recipient, the recipient may uncover the identification code and enter the identification code into the POS terminal 34. The recipient or the retail location employee may also enter a desired debit amount into the POS terminal 34, at step 202. Next, at step 204, the POS terminal 34 transmits the card input and the desired debit amount to authorization host 44, which transmits the card input and the desired debit amount to the host computer system 20.

After receiving the card input, the host computer 20 system compares the card input to the stored payout card identifying information, as indicated at step 206. If the card input does not match the payout card identifying information, then the host computer system 20 may request that the card input be re-entered, as indicated at step 208. If, after one or more subsequent attempts, the card input still does not match the payout card identifying information, then the transaction may be terminated. If, on the other hand, the card input matches the payout card identifying information, then the host computer system 20 may authorize or otherwise allow the POS terminal 34 and/or authorization host 44 to debit some or all of the payout funds, corresponding to the desired debit amount, from the payout account, at step 210. Transactions fees, if any, under this approach may also be handled in a similar manner as described above in detail.

It is anticipated that each payout card will only be used for a single receive transaction, which may include multiple withdrawals from one or more ATM's and/or multiple debits using one or more POS terminals. Furthermore, each payout card may be discarded at the end of a particular receive transaction. Alternatively, each payout card may be configured for use with multiple receive transactions. In such a case, a particular recipient may use the same card and same identification code for multiple transactions, thereby improving customer loyalty and reducing payout card inventory costs for the financial services institution and/or receive-agent. In addition, each payout card may only be valid for a configurable amount of time, and then deactivated after such time has expired.

Advantageously, the method and system of the invention allow a recipient to obtain funds from a payout account at his/her convenience. Furthermore, the funds may be obtained in increments or all at once.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method for performing a money transfer receive transaction, the method comprising:
loading payout funds, corresponding to at least a portion of a desired amount of money to be transferred from a sender to a recipient, in a payout account associated with a payout card, such that the payout funds are electronically accessible by the recipient using the payout card.

2. The method of claim 1 further comprising authorizing issuance of the payout card to the recipient.

3. The method of claim 1 further comprising receiving at a host computer system, prior to the loading step, card identifying information associated with the payout card, and storing the card identifying information and payout funds on the host computer system.

4. The method of claim 3 further comprising receiving input associated with the payout card, comparing the input to the card identifying information stored on the host computer system, and allowing a portion of the payout funds to be debited from the payout account if the input matches the card identifying information stored on the host computer system.

5. The method of claim 3 further comprising receiving input associated with the payout card, comparing the input to the card identifying information stored on the host computer system, and allowing funds corresponding to a portion of the payout funds to be dispensed to the recipient if the input matches the card identifying information stored on the host computer system.

6. The method of claim 1 further comprising providing, by a host computer system, an account code corresponding to the payout account for transmission to a terminal so that the terminal may write the account code to the payout card, and storing the account code on the host computer system.

7. The method of claim 6 further comprising providing, by the host computer system, an identification code for use with the payout card and for transmission to the terminal so that the terminal may cause the identification code to be printed on a receipt, and storing the identification code on the host computer system.

8. The method of claim 7 further comprising receiving input associated with the payout card, comparing the input to the account code and identification code stored on the host computer system, and allowing a portion of the payout funds to be debited from the payout account if the input matches the account code and identification code stored on the host computer system.

9. The method of claim 7 further comprising receiving input associated with the payout card, comparing the input to the account code and identification code stored on the host computer system, and allowing funds corresponding to a portion of the payout funds to be dispensed to the recipient if the input matches the account code and identification code stored on the host computer system.

10. The method of claim 1 further comprising allowing the payout account to be debited by an amount sufficient to cover a transaction fee.

11. The method of claim 1 further comprising allowing the payout account to be exceeded by an amount sufficient to cover a transaction fee.

12. The method of claim 1 further comprising loading an additional amount in the payout account to cover a transaction fee.

13. The method of claim 12 further comprising automatically calculating the transaction fee.

14. The method of claim 1 further comprising authorizing issuance of a negotiable instrument to the recipient that corresponds to another portion of the desired amount of money to be transferred.

15. The method of claim 1 further comprising authorizing issuance of cash to the recipient that corresponds to another portion of the desired amount of money to be transferred.

16. The method of claim 1 wherein the payout card has been previously issued to the recipient.

17. A method for performing a money transfer transaction, the method comprising:
storing transaction data on a host computer system, wherein the transaction data includes a desired amount of money to be transferred to a recipient;
receiving transaction identifying information provided by the recipient;
comparing the transaction identifying information with the transaction data stored on the host computer system; and
loading payout funds corresponding to at least a portion of the desired amount of money to be transferred in a payout account associated with a payout card if the transaction identifying information matches the transaction data stored on the host computer system, such that the payout funds are electronically accessible by the recipient using the payout card.

18. The method of claim 17 further comprising authorizing issuance of the payout card to the recipient.

19. The method of claim 17 further comprising receiving at the host computer system, prior to the loading step, card identifying information associated with the payout card, and storing the card identifying information on the host computer system.

20. The method of claim 19 further comprising receiving input associated with the payout card, comparing the input to the card identifying information stored on the host computer system, and allowing funds corresponding to a portion of the payout funds to be dispensed to the recipient if the input matches the card identifying information stored on the host computer system.

21. The method of claim 19 further comprising receiving input associated with the payout card, comparing the input to the card identifying information stored on the host computer system, and allowing a portion of the payout funds to be debited from the payout account if the input matches the card identifying information stored on the host computer system.

22. The method of claim 17 further comprising providing, by a host computer system, an account code corresponding to the payout account for transmission to terminal so that the terminal may write the account code to the payout card, and storing the account code on the host computer system.

23. The method of claim 22 further comprising providing, by the host computer system, an identification code for use with the payout card and for transmission to the terminal so that the terminal may cause the identification code to be printed on a receipt, and storing the identification code on the host computer system.

24. The method of claim 23 further comprising receiving input associated with the payout card, comparing the input to the account code and identification code stored on the host computer system, and allowing a portion of the payout funds to be debited from the payout account if the input matches the account code and identification code stored on the host computer system.

25. The method of claim 23 further comprising receiving input associated with the payout card, comparing the input to the account code and identification code stored on the host computer system, and allowing funds corresponding to a portion of the payout funds to be dispensed to the recipient if the input matches the account code and identification code stored on the host computer system.

26. The method of claim 17 further comprising allowing the payout account to be exceeded by a predetermined amount in order to cover a transaction fee.

27. The method of claim 17 further comprising loading an additional amount in the payout account to cover a transaction fee.

28. The method of claim 27 further comprising automatically calculating the transaction fee using the host computer system.

29. The method of claim 17 wherein the payout card has been previously issued to the recipient.

30. A method for performing a money transfer transaction, the method comprising:
storing transaction data on a host computer system, wherein the transaction data includes a desired amount of money to be transferred from a sender to a recipient;
receiving transaction identifying information from a first terminal in communication with the host computer system;
comparing the transaction identifying information with the transaction data stored on the host computer system;
receiving at the host computer card identifying information associated with an anonymous payout card, wherein the card identifying information includes an account number;
storing the card identifying information on the host computer system;
loading payout funds, corresponding to at least a portion of the desired amount of money to be transferred, in an account associated with the account number and maintained on the host computer system, if the transaction identifying information matches the transaction data stored on the host computer system;
receiving input associated with the payout card from a second terminal in communication with the host computer system;
comparing the input to the card identifying information stored on the host computer system;
allowing funds corresponding to the payout funds to be dispensed to the recipient if the input matches the card identifying information stored on the host computer system; and
allowing the payout account to be exceeded by a predetermined amount in order to cover a transaction fee.

31. A method for performing a money transfer receive transaction, the method comprising:
entering card identifying information associated with a payout card into a receive-transaction initiating terminal that is in communication with a host computer system;
requesting via the receive-transaction initiating terminal that the host computer system load payout funds, corresponding to at least a portion of a desired amount of money to be transferred from a sender to a recipient, into a payout account associated with the payout card; and
providing the payout card to the recipient.

32. The method of claim 31 further comprising issuing a negotiable instrument to the recipient that corresponds to another portion of the desired amount of money to be transferred.

33. The method of claim 31 further comprising issuing cash to the recipient that corresponds to another portion of the desired amount of money to be transferred.

34. A system for performing a money transfer receive transaction, the system comprising:
a host computer system including instructions for loading payout funds, corresponding to a desired amount of money to be transferred from a sender to a recipient, in a payout account associated with a payout card, such that the payout funds are electronically accessible by the recipient using the payout card.

35. The system of claim 34 wherein the host computer system is operative to receive card identifying information associated with the payout card, and further includes instructions for storing the card identifying information.

36. The system of claim 35 wherein the host computer system is further operative to receive input associated with the payout card, and further includes instructions for comparing the input to the stored card identifying information, and instructions for allowing funds corresponding to a portion of the payout funds to be dispensed to the recipient if the input matches the stored card identifying information.

37. The system of claim 35 wherein the host computer system is further operative to receive input associated with the payout card, and further includes instructions for comparing the input to the stored card identifying information, and instructions for allowing a portion of the payout funds to be debited from the payout account if the input matches the stored card identifying information.

38. The system of claim 34 wherein the host computer system is operative to provide an account code corresponding to the payout account for transmission to a terminal so that the terminal may write the account code to the payout card, and to store the account code.

39. The system of claim 38 wherein the host computer system is further operative to provide an identification code for use with the payout card and for transmission to the terminal so that the terminal may cause the identification code to be printed on a receipt, and to store the identification code.

40. The system of claim 39 wherein the host computer system is further operative to receive input associated with the payout card, and further includes instructions for comparing the input to the stored account code and stored identification code, and instructions for allowing a portion of the payout funds to be debited from the payout account if the input matches the stored account code and stored identification code.

41. The system of claim 39 wherein the host computer system is further operative to receive input associated with the payout card, and further includes instructions for comparing the input to the stored account code and stored identification code, and instructions for allowing funds corresponding to a portion of the payout funds to be dispensed to the recipient if the input matches the stored account code and stored identification code.

42 The system of claim 34 wherein the host computer system further includes instructions for allowing the payout account to be exceeded by a predetermined amount in order to cover a transaction fee.

43. The system of claim 34 wherein the host computer system further includes instructions for loading an additional amount in the payout account to cover a transaction fee.

44. The system of claim 43 wherein the host computer system further includes instructions for automatically calculating the transaction fee.

45. A system for performing a money transfer transaction, the system comprising:
a host computer system for storing transaction data, wherein the transaction data includes a desired amount of money to be transferred to a recipient; and
a terminal in communication with the host computer system for receiving transaction identifying information and for transmitting the transaction identifying information to the host computer system;
wherein the host computer system is operative to compare the transaction identifying information with the stored transaction data, and is further operative to load payout funds corresponding to the desired amount of money to be transferred in a payout account associated with a payout card if the transaction identifying information matches the stored transaction data.

46. The system of claim 45 wherein the terminal is operative to receive card identifying information associated with the payout card, and is further operative to transmit the card identifying information to the host computer system, and wherein the host computer system includes instructions for storing the card identifying information and payout funds.

47. The system of claim 46 wherein the terminal includes a card reader for reading the card identifying information from the payout card.

48. The system of claim 46 wherein the host computer system is further operative to receive input associated with the payout card, and further includes instructions for comparing the input to the stored card identifying information, and instructions for allowing funds corresponding to a portion of the payout funds to be dispensed to the recipient if the input matches the stored card identifying information.

49. The system of claim 46 wherein the host computer system is further operative to receive input associated with the payout card, and further includes instructions for comparing the input to the stored card identifying information, and instructions for allowing a portion of the payout funds to be debited from the payout account if the input matches the stored card identifying information.

50. The system of claim 45 wherein the host computer system is operative to provide an account code corresponding to the payout account and to store the account code, and the terminal includes a card writer and is operative to receive the account code and to write the account code to the payout card using the card writer.

51. The system of claim 50 wherein the host computer system is further operative to provide an identification code for use with the payout card and to store the identification code, and the terminal is operative to receive the identification code and to cause the identification code to be printed on a receipt.

52. The system of claim 51 wherein the host computer system is further operative to receive input associated with the payout card, and further includes instructions for comparing the input to the stored account code and stored identification code, and instructions for allowing funds corresponding to a portion of the payout funds to be dispensed to the recipient if the input matches the stored account code and stored identification code.

53. The system of claim 51 wherein the host computer system is further operative to receive input associated with the payout card, and further includes instructions for comparing the input to the stored account code and stored identification code, and instructions for allowing a portion of the payout funds to be debited from the payout account if the input matches the stored account code and stored identification code.

54. The system of claim 45 wherein the host computer system further includes instructions for allowing the payout account to go negative by a predetermined amount in order to cover a transaction fee.

55. The system of claim 45 wherein the host computer system further includes instructions for loading an additional amount in the payout account to cover a transaction fee.

56. The system of claim 55 wherein the host computer system further includes instructions for automatically calculating the transaction fee.
